(19) United States
(12) Patent Application Publication
(10) Pub. No.: US 2014/0279100 A1
(43) Pub. Date: Sep. 18, 2014

(54) SYSTEMS AND METHODS FOR PROCESSING CARD TRANSACTIONS

(71) Applicant: Isaac Lay, BREA, CA (US)

(72) Inventor: Isaac Lay, BREA, CA (US)

(21) Appl. No.: 14/217,309

(22) Filed: Mar. 17, 2014

Related U.S. Application Data
(60) Provisional application No. 61/801,858, filed on Mar. 15, 2013.

(51) Int. Cl. G06Q 20/20; G06Q 20/22

(52) U.S. Cl. CPC G06Q 20/204; G06Q 20/22
USPC 705/17

(57) ABSTRACT

A card transaction platform, comprising a card reader configured to read a card for use in a transaction; and a card processing application in communication with the reader, the card processing application configured to: receive a service or product selection associated with a price, display the selected service or product description and price, receive a confirmation of the selected service and price, receive an image associated with the transaction, generate a receipt with a transaction summary and that include the image, and transmit the receipt to an address associated with the transaction.

### BACKGROUND

1. Technical Field

The embodiments described herein are related to mobile card transaction processing, and more particularly to an application that increases the value and experience for both the merchant and the consumer of card transactions.

2. Related Art

Mobile card processing applications, e.g., credit card processing applications can provide benefits to small merchants that cannot afford the costs and fees associated with credit card terminals. Conventional mobile card processing systems and applications do not, however unlock the full usefulness of conventional mobile devices.

### SUMMARY

A platform for mobile card processing that provides value added features and capabilities.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example mobile card processing platform in accordance with one embodiment;

FIG. 2 is an example mobile device with card reader and mobile card processing application that can be included in the platform of FIG. 1; and

FIG. 3 is a diagram illustrating a processing system on which one or more of the processes described herein may be executed, according to an embodiment

### DETAILED DESCRIPTION

FIG. 1 is a diagram illustrating an example mobile card processing platform 100 for processing card transactions. The platform can be implemented on a mobile communications device such as a cellphone, smartphone, tablet device, etc. As can be seen, the platform 100 comprises a card reader 102 that can read a card, e.g., can read the magnetic stripe on a card. Alternatively, the reader 102 can be a contactless reader.

Platform 100 also comprises a processing application 106 that allows the user to select one or more services stored in database 104 associated with the transaction. The application can be accessed by clicking on or tapping an icon displayed on the mobile communication device. When the icon is activated, the application will launch and the user can select a service or product. In certain embodiments, predictive text input can be used, such that the user can simply begin typing in the name of the service or product and options will appear.

Users can create and save a custom list of products and services (“items) to the application 106 for storage in database 104 for future reference. The user can also link a dollar amount to the items when they create and save them. In addition to being able to scroll through a list of saved items, a user can also have the option of searching for items using a search function. This search function can allow the user to type in the first letter of the item(s) they previously created. As they type a letter, all saved items and suggestions appear in a scrollable list. This scrollable list makes it much easier to locate an item compared having to tap a button and then scroll through a list to locate the appropriate item. If the user already knows that the item they are looking for begins with an “h,” they need only type “h” to be presented with a list of all items that begin with the word “h.” Rather than having to type out the full description of the product or service, they can select from the list they created. Other options include being able to create a custom code or tag that allows the user to easily search for and retrieve the item they previously created and saved to the application 106.

In, e.g., salons, spas and nail shops, it is common practice for a hair stylist or receptionists to ask the client if they'd like to add a tip. This can be uncomfortable for both the client and the hair stylist (or nail technician, esthetician, receptionist, etc . . . ). Since tips can represent 10-20% or more of the hair stylists annual income, the discomfort is endured to ensure the tip is received. Application 106 eliminates this discomfort by providing a process that allows the stylist to generate a total and then hand their phone to the client for approval. The client is then presented with what we call the Client View. This view allows the client to confirm that the service and the amount is correct. From the client's perspective, they think they're just approving the service that was performed and the corresponding amount. After the amount is approved, our app then asks the client if they'd like to add a tip. The client then has the option to “Skip Tip” or “Add Tip.” If they tap “Add Tip,” the client is taken to a screen that allows them to easily input a tip amount in any dollar amount they choose. After the tip is entered and they approve the final total, instructions tell them to return the phone to their stylist along with their card.

Transaction information can be stored, e.g., in database 104. The user can then pull up this information to quickly and easily see transaction data, transaction totals, tip totals, etc. The transaction information is also forwarded via radio 110 and antenna 111 for processing. A backend server can also store the data so that the user can access a website and pull up transaction information and history, e.g., in a dashboard.

Certain embodiments include an option for clients to give to charity. On the Client View, a client can tap a “+” or “−” button and include a small donation to their total. Each tap of the “+” button allows the client to easily add a small amount to their total without having to calculate the total themselves. By linking a small amount to each tap, like 25¢, it represents an insignificant amount so clients are more likely to give. As the client continues to tap, the amount a client can give becomes greater.

After a transaction is completed and approved and the customer signs on the, e.g., stylist's phone using their finger or a stylus, the stylist has the option of sending a receipt via email. Additionally, the stylist can take a headshot of the client and include it in the receipt that is sent via email. This photo could be a picture of the client's hair, nails, toes, a tattoo, etc. The receipt the client receives will contain the photo the stylist took. Next to the photo is a call-to-action that requests that the client share their photo on Facebook or Twitter, or other social media outlets. If the client shares their photo on one of their social media outlets, a marketing opportunity ensues for the stylist. Next to the clients photo is a call-to-action that requests that the client's friends contact the stylist for an appointment. The text that appears next to the client photo can include a phone number for an appointment or even a link to a schedule whereby the friends of the client can schedule an appointment with the stylist. Other options include a way for the client to approve the photo for use in the stylist's portfolio, whereby friends who want to view a stylists portfolio of work, can view these client-approved images.

FIG. 2 illustrates a mobile device running application 106 and interfaced with a reader 102.

Appendix A includes specifications for an example implementation of the back end system, the dashboards that can be accessed thereon, and the application 106 that can comprise the mobile card processing platform described herein.

Appendix B includes wireframes of example screens that can form the client dashboard accessed via the backend system in accordance with one example implementation.

Appendix C includes wireframes illustrating an example process for enrolling as a merchant in accordance with one example implementation.

Appendix D includes wireframes illustrating transaction processing using application 106 in accordance with one example implementation.

FIG. 3 is a block diagram illustrating an example wired or wireless system 550 that can be used in connection with various embodiments described herein. For example the system 550 can be used as or in conjunction with one or more of the mechanisms or processes described above, and may represent components of application 106, the corresponding backend server(s), and/or other devices described herein. The system 550 can be a server or any conventional personal computer, or any other processor-enabled device that is capable of wired or wireless data communication. Other computer systems and/or architectures may be also used., as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB). IEEE 696/5-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RIP”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RE signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RE carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory. ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A card transaction platform, comprising:
a card reader configured to read a card for use in a transaction; and
a card processing application in communication with the reader, the card processing application configured to:
receive a service or product selection associated with a price,
display the selected service or product description and price,
receive a confirmation of the selected service and price,
receive an image associated with the transaction,
generate a receipt with a transaction summary and that include the image, and
transmit the receipt to an address associated with the transaction.

2. The platform of claim 1, wherein the application is further configured to receive a tip amount and include the tip amount in the transaction processing.

3. The platform of claim 1, wherein the image is a headshot, and image of a customer's finger nails, toe nails, or a tattoo.

4. The platform of claim 1, wherein the processor is further configured to include a call-to-action that requests that the recipient of the receipt share the photo include therewith on Facebook or Twitter, or other social media outlets.

5. The platform of claim 4, wherein the receipt also includes a call-to-action such that of the recipient shares the photo a requests that the client's friends contact the stylist for an appointment is presented with the photo.

6. The platform of claim 5, wherein the request presented with the photo includes a phone number or a link to a schedule an appointment.

7. The platform of claim 4, wherein the call-to-action requests that the recipient approve the photo for use in the stylist's portfolio.

8. The platform of claim 1, wherein the application is further configured to require that the owner or user of the smartphone handover the smartphone to the customer whereby the client can enter the tip amount themselves.

9. The platform of claim claim 1, wherein the client can add a donation by tapping a button that corresponds to a fixed amount that increases with each tap of said button
